(19) United States
(12) Patent Application Publication
(10) Pub. No.: US 2020/0226150 A1
(43) Pub. Date: Jul. 16, 2020

(54) COMPARING MAP BUILDS USING HIERARCHICAL TREE REPRESENTATIONS

(71) Applicant: Uber Technologies, Inc., San Francisco, CA (US)

(72) Inventors: Houtan Shirani-Mehr, Santa Clara, CA (US); Xiaowei Li, San Carlos, CA (US); Vitaliy Stulski, Los Gatos, CA (US); Daniel Wolf, Menlo Park, CA (US)

(21) Appl. No.: 16/249,788

(22) Filed: Jan. 16, 2019

(51) Int. Cl. G06F 16/28; G01C 21/32; G06F 16/22; G06F 16/29

(52) U.S. Cl. CPC G06F 16/282; G01C 21/32; G06F 16/29; G06F 16/2255; G06F 16/2246

(57) ABSTRACT

A computing system uses tree data structures summarizing map builds to identify differences between map builds. The tree data structures include nodes summarizing portions of geographic regions of map builds. Responsive to a request to compare a first and second map build, the computing system accesses the tree data structures for the first and second map builds and identifies differences by traversing the tree data structures in lockstep and comparing the hash values for corresponding nodes in the tree data structures. The computing system traverses the tree data structures by identifying nodes that are different between the tree data structures until one or more bottom-level nodes are identified as different. The computing system identifies map features corresponding to the identified bottom-level nodes as different and transmits the identified map features to a client device associated with the request.

### BACKGROUND

This disclosure relates generally to summarizing and comparing map builds, and more specifically to comparing map build features using hierarchical tree representations.

A computing system stores and maintains one or more map builds representing geographic regions for use during transport services. A map build includes information describing characteristics of a geographic region, including road segments, intersections, lots, addresses, and the like. Map builds may be used during transport services to provide routing information, to assign transport service providers and users, and to determine timing information for transport service rides. Accordingly, it is important that map builds accurately represent characteristics of the geographic region.

Maintaining an accurate map build for a geographic region may require that the computing system update the map build when updated, corrected, or new information is received for the geographic region. However, transitioning between a first map build and a second map build often presents challenges in identifying and handling differences between the map builds. Differences in map builds may be deliberate (e.g., new information describing a feature of the map build) or accidental (e.g., an error in the map build). The computing system determines locations in the map builds where errors occur and where deliberate changes are committed from one map to the next to verify that any differences between the first and second map builds are deliberate.

Current methods for identifying differences in map builds require large amounts of time or data processing. In one method, for each pair of map builds, a map feature in each map build is compared to determine whether the feature has been modified. The computing system performs the comparison as a batch process that takes many hours. In another method, the computing system applies a process that zooms into a specific area of a pair of high resolution maps, loads all map features for the specific area, and compares the corresponding map features in the pair of maps. This method requires a large amount of computational resources including processing power, storage resources, and communication resources and is likewise inefficient to perform. Accordingly, there is a need for a method to identify differences in map builds quickly and efficiently with regards to computational time and data processing.

### SUMMARY

According to various embodiments, a computing system identifies differences between map builds using hierarchical tree data structures that summarize features of the map builds. The tree data structures include nodes summarizing a portion of the geographic region of the map build. A node is associated with a hash value of identifiers and feature attributes of map features included in the portion of the geographic region. For example, a top-level node summarizes a first portion of the geographic region and includes one or more nodes summarizing smaller partitions of the geographic region. In one embodiment, a lowest-level node of the tree data structure represents a geographic region including a single map feature. In other embodiments, a lowest-level node of the tree data structure represents a smaller partition of the geographic region including multiple map features. The computing system stores and maintains tree data structures for map builds.

Responsive to receiving a request to compare a first and second map build, the computing system accesses tree data structures for the first and second map builds. The computing system identifies differences between the first and second map builds by traversing the tree data structures in lockstep and comparing the hash values for corresponding nodes in the tree data structures. For example, the computing system identifies a first top-level node of the first tree data structure and a second top-level node of the second tree data structure corresponding to the first node. The computing system traverses the tree data structures by identifying nodes that are different between the tree data structures until one or more bottom-level nodes are identified as containing differences. The computing system identifies the map features corresponding to the bottom-level nodes and transmits data describing the map features to a client device associated with the request.

By using hierarchical tree data structures, the computing system is able to efficiently identify portions of the geographic region containing differences between two map builds without requiring a high resolution comparison or a computation-intensive search through each corresponding pair of map features. Additionally, hierarchical tree data structures can be built to address a variety of needs. For example, the computing system may build and compare tree data structures summarizing a particular map feature type.

### BRIEF DESCRIPTION OF THE DRAWINGS

FIG. 1 is a block diagram of a system environment for a computing system including a map build system, in accordance with an embodiment.

FIG. 2 is a block diagram of an architecture of the map build system, in accordance with an embodiment.

FIG. 3 is an example illustrating features associated with a portion of a map build, in accordance with an embodiment.

FIG. 4 is an example quad tree summarizing a map build, in accordance with an embodiment.

FIGS. 5A-5B are an example illustrating a comparison between a first and second quad tree summarizing a first and second map build, respectively, in accordance with an embodiment.

FIG. 6 is a flow diagram of a method for generating a quad tree based on a map build, in accordance with an embodiment.

FIG. 7 is a flow diagram of a method for comparing a first and second quad tree to identify differences between a first and second map build, in accordance with an embodiment.

FIG. 8 is a high-level block diagram illustrating physical components of a computer used as part or all of one or more of the entities described herein in one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

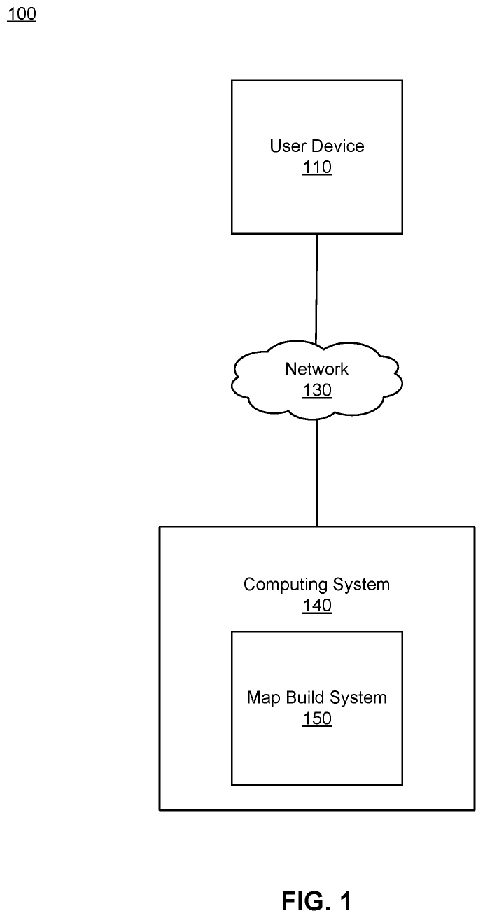

FIG. 1 is a high-level block diagram of a system environment for a computing system 140, in accordance with some embodiments. FIG. 1 includes a user device 110, a network 130, and the transport service system 140. For clarity, only one user device 110 is shown in FIG. 1. Alternate embodiments of the system environment can have any number of user devices 110 as well as multiple systems 140. The functions performed by the various entities of FIG. 1 may vary in different embodiments. In one embodiment, the computing system is a transport service system. The transport service system may provide routing, direction, and timing information to the user device 110. For example, the transport service system may coordinate travel, for example, by matching a rider with a vehicle for transporting the rider, items, or services to a destination requested by a rider. The vehicle may be associated with a driver or may be an autonomous vehicle.

User devices 110 can be personal or mobile computing devices, such as smartphones, tablets, or notebook computers. In some embodiments, the user device 110 executes a client application that uses an application programming interface (API) to communicate with the computing system 140 via the network 130. When the computing system 140 is a transport service system, the user device 110 can be a rider device, a driver device, or a device for maintaining and updating the computing system 140. For example, an administrator or engineer/developer of the computing system 140 communicates with the system via a user device 110 to validate map builds or changes made to map builds. In another example, a rider or driver of a transport service system communicates with the computing system 140 via a user device 110 to determine information, such as traffic data change, associated with a route.

The user devices 110 can communicate with the computing system 140 via the network 130, which may comprise any combination of local area and wide area networks employing wired or wireless communication links. In some embodiments, all or some of the communication on the network 130 may be encrypted.

The computing system 140 shown in FIG. 1 includes a map build system 150. A map build system 150 stores and maintains map builds for the computing system 140. A map build is a representation of a geographic area. In one embodiment, the map build system 150 stores and maintains one or more map builds for a number of different geographic areas. Based on information associated with map builds describing the geographic area, the map build system 150 provides ground truth information to the computing system 140, which provides routing, direction, and timing information to user devices 110.

For geographic regions associated with one or more map builds, or in the case that a new or updated map build is provided for a geographic region, the map build system 150 uses tree data structures to identify differences between map builds. The tree data structures include nodes summarizing a portion of the geographic region. By using tree data structures to represent and compare complex map builds, the map build system 150 is able to efficiently identify differences between map builds without requiring a high resolution comparison of map data or a computation-intensive search through each pair of map features of the map builds. Accordingly, the map build system 150 is able to perform a thorough comparison of map builds without requiring large amounts of computational resources, such as processing power, storage resources, and communication resources, associated with conventional methods for comparison.

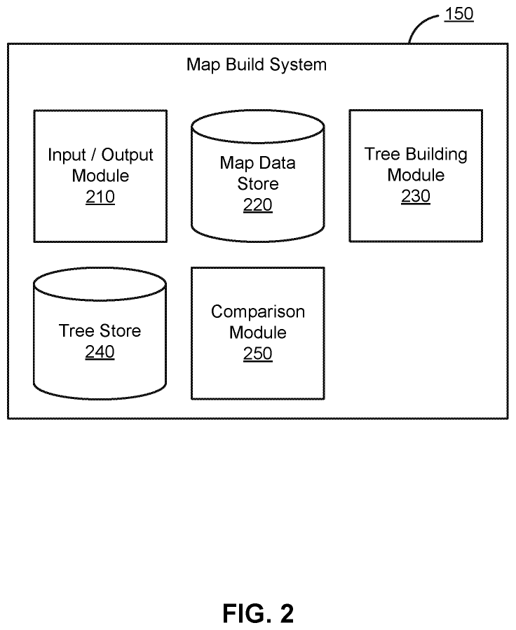

FIG. 2 is a block diagram of a system architecture for the map build system 150, in accordance with some embodiments. The map build system 150 includes various modules and data stores to store, maintain, and update map builds for the computing system 140. The map build system 150 comprises an input/output module 210, a map data store 220, a tree building module 230, a tree store 240, and a comparison module 250. Computer components such as web servers, network interfaces, security functions, load balancers, failover servers, management and network operations consoles, and the like are not shown so as to not obscure the details of the system architecture. Additionally, the map build system 150 may contain more, fewer, or different components than those shown in FIG. 2 and the functionality of the components as described herein may be distributed differently from the description herein.

The input/output module 210 communicates with systems/devices external to the map build system 150, for example, by receiving requests from other systems and transmitting results of processing the requests to these systems. In an embodiment, the input/output module 210 receives requests from user devices 110 to identify differences between a first and a second map build stored in the map build system 150. The request is associated with a user identifier associated with the user device 110. In an embodiment, the first and second map builds represent the same geographic area. Based on the request, the input/output module 210 identifies the first and second map builds from the map data store 220 and transmits the request to the comparison module 250 for a comparison to be performed.

The input/output module 210 additionally transmits identified differences between a first and second map build to a user device 110 associated with requesting the differences. In different embodiments, the input/output module 210 may transmit the identified difference in different ways. In one example, the input/output module 210 transmits a user interface to the user device 110 that allows a user to navigate through the map build to view identified differences, wherein the identified differences are flagged. In another example, the input/output module 210 transmits a graphical representation of a hierarchical data structure to the user device 110 that highlights the identified differences between the map builds. In another example, the input/output module 210 transmits text to the user device 110 specifying the identified differences (e.g., using unique identifiers associated with map features that are different between the builds).

The map data store 220 stores and maintains one or more map builds for a number of geographic locations. Each map build includes information describing characteristics of the geographic area, called “map features.” A map feature represents an object, structure, or element of a map (for example, a road segment) and includes one or more attributes of an object, structure, or element of the map (for example, speed limit on a road segment). Examples of map features include representation of road segments, road segment classes, road segment names, street names, road intersections, road signs, speed limits, addresses, maneuver types, maneuver directions, and the like on a map. In an embodiment, the map data store 220 stores one or more map builds for a geographic location. For example, one map build may be an updated version of a second map build for the same geographic region and may include updates to map features such as road closures, new road construction, speed profile updates, and the like. In another example, one or more map builds may be used to represent different subsets of map features (e.g., a map build for all road segments in a geographic location; a map build for all addresses and lots in a geographic location). Each map feature in a map build is associated with a unique identifier and a set of attributes describing the map feature. For example, attributes for a map feature include geometry of the map feature, status of the map feature (e.g., under construction, temporarily or permanently closed, etc.), traffic associated with the map feature, and the like. Additionally, attributes for a map feature may be specific to a type of map feature. For example, a map feature representing a road segment is associated with attributes describing a number of lanes for the road segment, traffic directionality of the road segment, a name of the road segment, and the like.

The tree building module 230 generates one or more tree data structures that represent map builds such that the map builds can be compared by the comparison module 250. In one embodiment, the tree building module 230 builds a tree data structure for a map build upon receiving a request from the input/output module 210 to identify differences between a first and second map build. In another embodiment, the tree building module 230 builds a tree data structure for a map upon the map build data structure being added to or updated in the map data store 220. For example, the tree building module 230 builds the tree data structure for a map build offline and stores the generated tree data structure such that the map build system 150 is able to access the tree data structure responsive to a user request.

The tree building module 230 accesses the map data store 220 to identify a map build. For each map feature in the map build, the tree building module 230 identifies a unique identifier for the map feature and a set of attributes for the map feature. The tree building module 230 accesses all map features represented in a given node and generates a hash value for the unique identifiers and the sets of attributes of each map feature in the node. In one embodiment, the tree building module 230 applies a sorting algorithm to attributes of map features for the map builds to ensure that map features and attributes of map features correspond between the map builds. For example, the tree building module 230 sorts the attributes in alphabetical order. In other examples, other sorting algorithms may be used. Based on the hash values for the map feature identifiers and attributes, the tree building module 230 generates a tree data structure. Each tree data structure is made of one or more nodes, where each node summarizes a portion of the geographic region associated with the map build. For example, the tree data structure may be a quad tree. In other examples, the tree data structure may be any other tree structure including nodes. In one embodiment, the tree building module 230 generates a tree data structure for a subset of map features. For example, the tree building module 230 identifies a subset of map features based on a map feature type (e.g., road segments, road signs, lots with addresses, etc.). The generated tree data structure accordingly summarizes the selected subset of map features. In another embodiment, the tree building module 230 generates a tree data structure for all map features of a map build.

The tree store 240 stores and maintains tree data structures summarizing map builds generated by the tree building module 230. The tree store 240 associates the stored tree data structures with the map builds represented by the tree data structures. In an embodiment, the tree store 240 includes one or more versions of tree data structures corresponding to one or more versions of map builds for a geographic region. For example, the tree store 240 may include one or more past versions of map builds or one or more versions of map builds for subsets of map features.

The comparison module 250, compares to map builds to identify differences between them. The comparison module 250, responsive to receiving a request to identify differences between a first and a second map build from the input/output module 210, traverses a first and second tree data structure for the respective first and second map builds to identify differences between the map builds. The comparison module 250 accesses the tree store 240 and retrieves a first and second tree data structure summarizing the first and second map builds based on the request. The comparison module 250 identifies a root node for the first and second tree data structures, the root node of the first tree data structure corresponding to the root node of the second tree data structure. In one embodiment, the identified root nodes summarize the entire geographic region of the map build. The comparison module 250 traverses the first tree data structure via a first path from the first root node and traverses the second tree data structure via a second path identical to the first path, the first and second paths selected by identifying hash values of the first and second tree data structures that are distinct. In different examples, the comparison module 250 uses different tree traversal techniques. In one example, the comparison module 250 checks the child nodes of each root node in a clockwise pattern (e.g., the northwestern node, the northeastern node, the southeastern node, the southwestern node) to determine which child nodes to traverse. In another example, the comparison module 250 checks the child nodes of each root node in a top to bottom and left to right pattern (e.g., northwestern, northeastern, southwestern, southeastern).

The comparison module 250 identifies a difference in the first and second map builds responsive to identifying a first node in the first tree data structure and a second node in the second tree data structure. The position of the first node within the first tree data structure matches the position of the second node in the second tree data structure. Accordingly, the first node is reached by performing a traversal within the first tree data structure that matches the corresponding traversal used to reach the second node in the second tree data structure. However, the hash values for the first and second nodes may be distinct. For example, the comparison module 250 determines that the first and second nodes have identical identifier hash values and different feature attribute hash values. The comparison module 250 accordingly flags the nodes as representing a change in the feature attributes of the map feature associated with the first and second nodes.

In another example, the comparison module 250 identifies a node in the first tree data such that there is no corresponding node in the second tree data structure. For example, if the first node is reached by performing a traversal through the first tree data structure, there is no node that is reached by performing an identical traversal of the second tree data structure. Accordingly, the comparison module 250 identifies a node in the first tree data structure with an identifier hash value that is not included in a corresponding node of the second tree data structure. The comparison module 250 accordingly flags the first node as representing a deletion or addition of a map feature associated with the first node.

### Comparing Map Builds Using Hierarchical Tree Representations

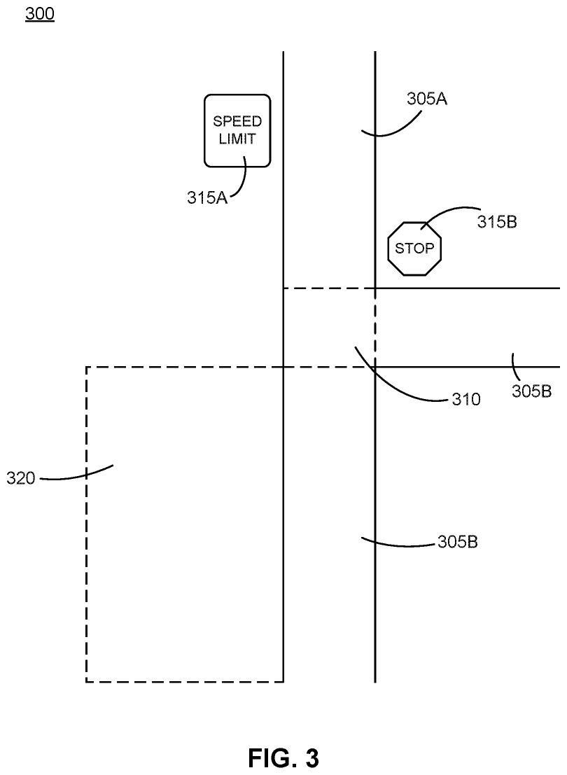

FIG. 3 is an example illustrating features associated with a portion of a map build. A portion of a geographic location 300 represented in a map build includes a number of map features, including road segments 305, a road intersection 310, road signs 315, and a lot 320. Each map feature is associated with a unique identifier and a set of attributes describing the map feature. For example, a first road segment 305A is associated with a different identifier than road segments 305B and 305C. Additionally, the road segment 305A is associated with a set of attributes. For example, the attributes specify that the road segment 305A runs north to south, that traffic on the road segment is associated with a speed limit profile based on a road sign 315A associated with the road segment, that the road segment is associated with a street name, and that the road segment intersects with road segments 305B and 305C at an intersection 310. Similarly, the lot 320 is associated with a set of attributes. For example, the attributes specify an address, an access point (e.g., a driveway or parking lot entrance), ownership info (e.g., business name, private residence, etc.), and that it is located off of a road segment 305C. In other examples, other attributes may be associated with map features in the map build.

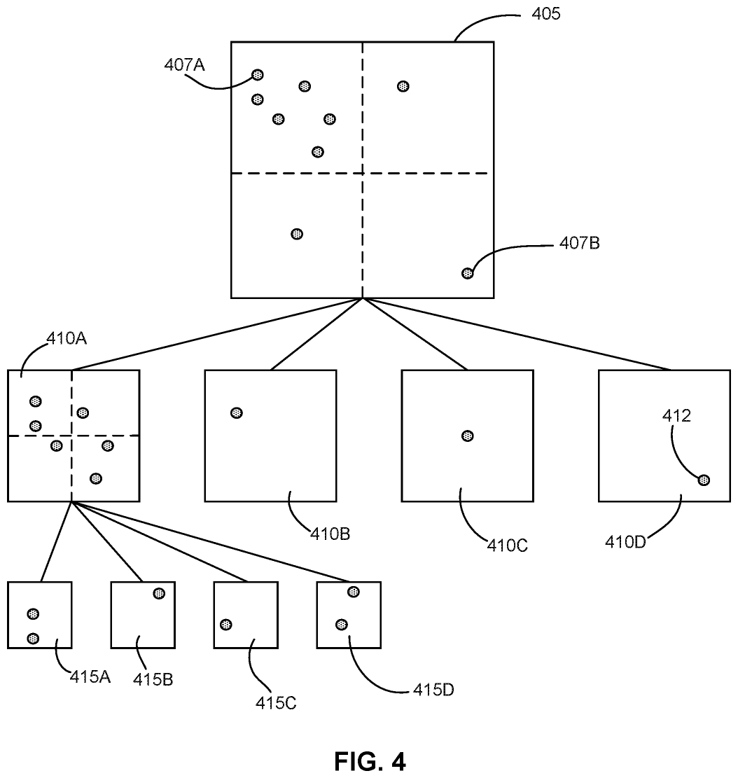

FIG. 4 is an example quad tree summarizing a map build. A map build representing a geographic region is represented by a quad tree including several hierarchical levels of nodes. In other embodiments, the quad tree may include fewer or additional hierarchical levels than those illustrated in FIG. 4. Furthermore, each node may have more or fewer children nodes than those indicated in FIG. 4. A first top-level node 405 represents the geographic region and includes a plurality of map features 407 included in the geographic region. The top-level node 405 is partitioned into four equivalent nodes 410A-410D, wherein each node represents an equal portion of the geographic region of the map build. The top-level node 405 is associated with a hash value based on the hash values of the nodes 410A-410D contained by the top-level node.

As shown in the example of FIG. 4, the nodes 410B, 410C, and 410D each include one map feature. Accordingly, the nodes 410B, 410C, and 410D are associated with a hash value based on the included map feature. For example, the node 410D is represented by a hash value describing the identifier and feature attributes of the map feature 412. The node 410A includes a second plurality of map features, the second plurality of map features being a subset of the plurality of map features represented in the top-level node 405. The node 410A is partitioned into four equivalent nodes 415A-415D, wherein each node represents an equal portion of the geographic region of the map build summarized by 410A. The partitioning occurs iteratively through the tree data structure, such that each bottom-level node includes one map feature. In some embodiments a bottom-level node may include multiple map features, for example, a set of map features represented using a list data structure.

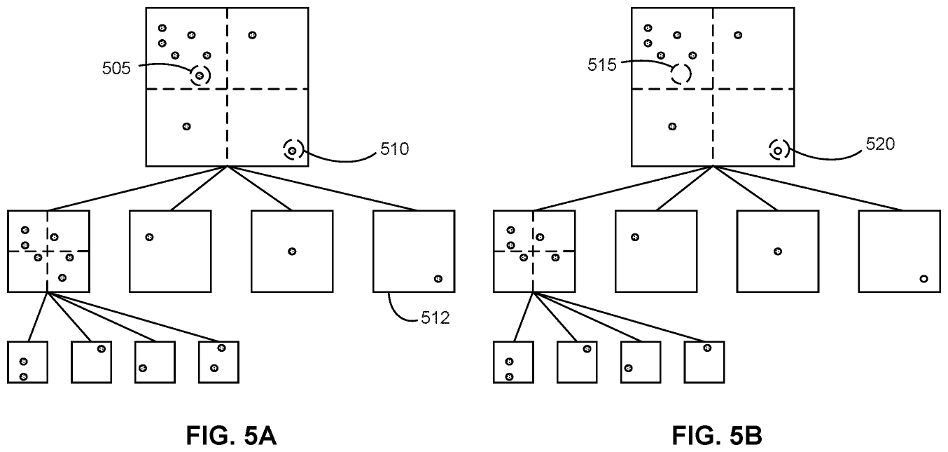

FIGS. 5A-5B are an example illustrating a comparison between a first and second quad tree summarizing a first and second map build, respectively. FIG. 5A illustrates a first quad tree summarizing a first map build, including a first map feature 505 and a second map feature 510. FIG. 5B illustrates a second quad tree summarizing a second map build, including an absence of a map feature 515 corresponding to the first map feature in the first quad tree and a modified second map feature 520 corresponding to the second map feature in the first quad tree. For example, the absent map feature 515 may correspond to a map feature that no longer exists (e.g., permanent closure of a road segment or removal of a road sign), while the modified second map feature 520 may correspond to a map feature that has undergone a change (e.g., change in road segment name, change in property ownership, etc.). In another example, the absent map feature 515 and the modified second map feature 520 may be errors in the second map build.

Responsive to a request to compare the first map build summarized by the first quad tree in FIG. 5A and the second map build summarized by the second quad tree in FIG. 5B, the computing system 140 compares hash values of the top-level nodes of the respective quad trees. When the computing system 140 detects a difference in the hash values, the computing system 140 traverses the quad trees in lockstep to nodes with hash values representing the changed map features. For example, the computing system 140 determines that the hash values associated with the first and fourth quadrants of the top-level nodes are different between the first and second quad trees. Responsive to the determination, the computing system 140 traverses the quad trees to the first and fourth quadrants and iterates the process until a node representing a map feature is identified in the quad trees as different. For example, the computing system 140 traverses the quad tree from the root node to the fourth quadrant 512 and identifies a node contained in the fourth quadrant as being different between the first and second quad trees. The computing system 140 may traverse a quad tree using a tree traversal technique, for example, using a breadth first traversal or a depth first traversal, or any other tree traversal. To perform lock step traversal of two trees, the computing system 140 iterates through the children nodes of a node in the same order for the two trees.

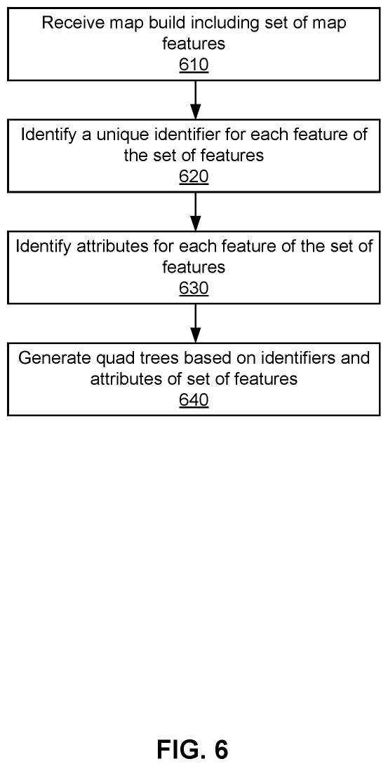

FIG. 6 is a flow diagram of a method for generating a quad tree based on a map build. In various embodiments, the method may include different and/or additional steps than those described in conjunction with FIG. 6.

The map build system 150 receives a map build including a set of map features. For each feature of the set of map features, the map build system 150 identifies a unique identifier and additionally identifies 630 attributes associated with each feature in the map build. The map build system 150 generates 640 one or more hierarchical tree data structures, such as a quad tree, based on the identifiers and attributes. In one embodiment, the map build system 150 generates a hierarchical tree data structure for one or more specified map feature types. In an embodiment, the map build system 150 stores the generated hierarchical tree data structure on the system.

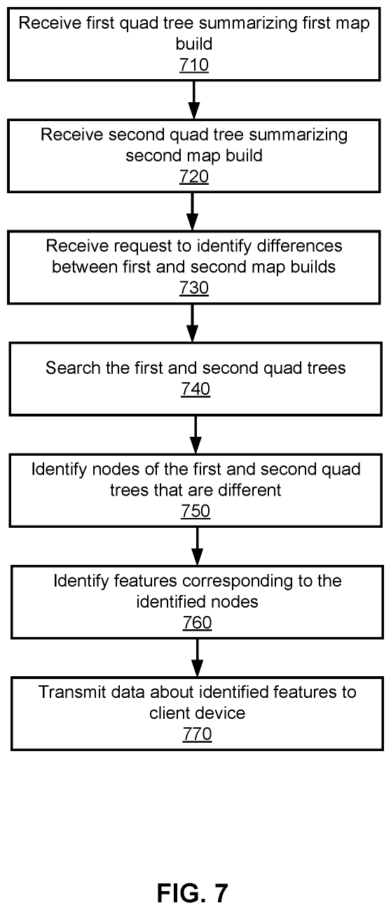

FIG. 7 is a flow diagram of a method for comparing a first and second quad tree to identify differences between a first and second map build. In various embodiments, the method may include different and/or additional steps than those described in connection with FIG. 7.

The map build system 150 receives 710 a first quad tree summarizing a first map build and receives 720 a second quad tree summarizing a second map build. The first and second quad trees include one or more nodes that represent features of the first and second map builds, respectively. Each node includes an identifier hash value and one or more feature attribute hash values. In one embodiment, the first and second quad trees are generated by the map build system 150 based on the first and second map builds respectively, as described in conjunction with FIG. 6. The map build system 150 receives 730 a request to identify differences between the first and second map builds. Responsive to the request, the map build system 150 searches 740 the first and second quad trees and identifies 750 nodes of the first and second quad trees that are different. For example, the map build system 150 traverses the first and second quad trees via identical paths from a root node of each quad tree to determine nodes that are associated with distinct identifier or attribute hash values. The map build system 150 identifies 760 features of the map builds that correspond to the nodes of the first and second quad trees that are different and transmits 770 data about the identified features to a client device 110 associated with the request.

### Example Computer System

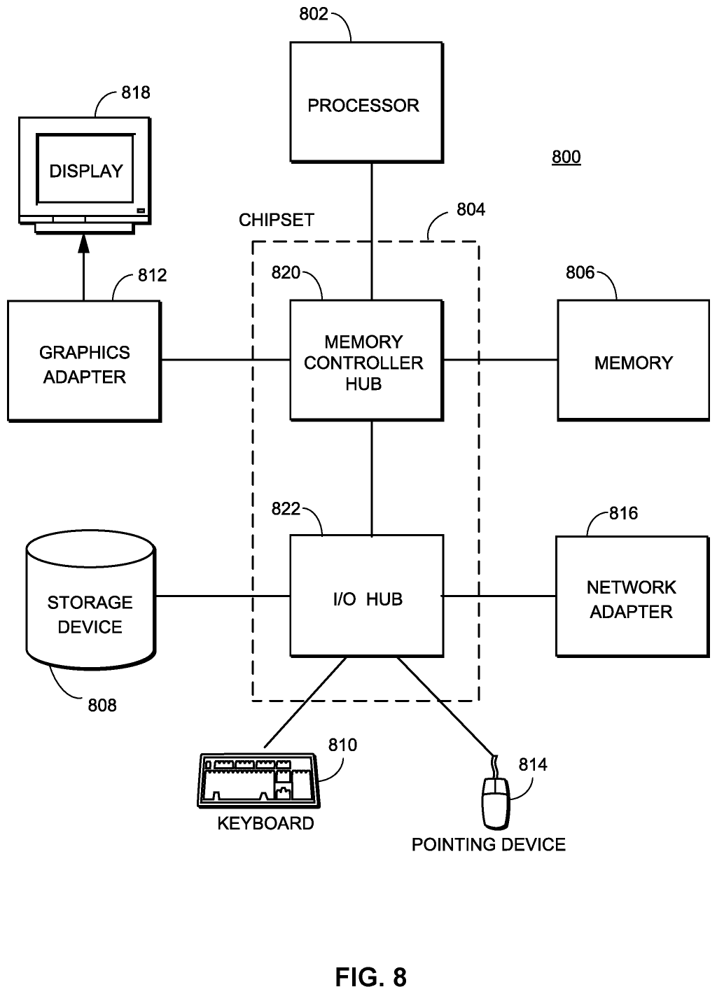

FIG. 8 is a high-level block diagram illustrating physical components of a computer 800 used as part or all of one or more of the computing systems described herein in one embodiment. For example, instances of the illustrated computer 800 may be used as a server operating the computing system 140. Illustrated are at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O hub 822. In another embodiment, the memory 806 is coupled directly to the processor 802 instead of the chipset 804. In one embodiment, one or more sound devices (e.g., a loudspeaker, audio driver, etc.) is coupled to chipset 804.

The storage device 808 is any non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer 800. The graphics adapter 812 displays images and other information on the display 818. The network adapter 816 couples the computer system 800 to a local or wide area network.

As is known in the art, a computer 800 can have different and/or other components than those shown in FIG. 8. In addition, the computer 800 can lack certain illustrated components. In one embodiment, a computer 800 acting as a server may lack a keyboard 810, pointing device 814, graphics adapter 812, and/or display 818. Moreover, the storage device 808 can be local and/or remote from the computer 800 (such as embodied within a storage area network (SAN)).

As is known in the art, the computer 800 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 808, loaded into the memory 806, and executed by the processor 802.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for comparing map builds using quad tree data structures, the method comprising:
receiving a first map build for a geographic region, the first map build including a first set of map features, wherein each map feature is associated with a location within the geographic region and has one or more attributes;
receiving a second map build for the geographic region, the second map build including a second set of map features;
building a first quad tree based on the first map build and a second quad tree based on the second map build, wherein each of the first quad tree and the second quad tree comprises nodes, each node associated with a portion of the geographic region and storing a hash value based on the portion of the geographic region, wherein the hash value of a node is determined based on one or more of: map features of the portion of the geographic region associated with the node or hash values of one or more nodes below the node;
receiving, from a client device, a request to compare the first map build and the second map build;
identifying a first node of the first quad tree and a second node of the second quad tree corresponding to the first node of the first quad tree such that the hash value associated with the first node is distinct from the hash value associated with the second node;
identifying one or more features from the first and second sets of map features, the one or more features representing a difference between the portion of the geographic region corresponding to the first node and the portion of the geographic region corresponding to the second node; and
transmitting data describing the one or more features to the client device for display via a user interface.

2. The method of claim 1, wherein map features include one or more of: road segments, road segment classes, road segment names, street names, road intersections, road signs, speed limits, addresses, maneuver types, or maneuver directions.

3. The method of claim 1, wherein building each of the first quad tree and the second quad tree comprises:
identifying a unique identifier for each map feature of the set of map features;
identifying a set of attributes for each map feature of the set of map features; and
generating a quad tree including nodes representing hash values for the unique identifiers and attributes for each map feature.

4. The method of claim 3, wherein the set of attributes for each map feature includes one or more of: geometry of map features; status of map feature; or traffic associated with map feature.

5. The method of claim 1, wherein identifying a first node of the first quad tree and a second node of the second quad tree corresponding to the first node of the first quad tree such that the hash value associated with the first node is distinct from the hash value associated with the second node further comprises:
identifying the first node in the first quad tree, the first node including a first identifier hash value and a first feature attribute hash value;
identifying the second node in the second quad tree, the second node corresponding to the first node in the first quad tree and including a second identifier hash value and a second feature attribute hash value;
determining the first and second identifier hash values are identical; and
determining the first and second feature attribute hash values are different.

6. The method of claim 1, wherein identifying a first node of the first quad tree and a second node of the second quad tree corresponding to the first node of the first quad tree such that the hash value associated with the first node is distinct from the hash value associated with the second node further comprises:
identifying a node in the first quad tree, the node including an identifier hash value; and
determining that the identifier hash value is not included in a corresponding node of the second quad tree.

7. The method of claim 1, wherein the first quad tree has a first root node and the second quad tree has a second root node, and wherein identifying the first node of the first quad tree and the second node of the second quad tree comprises:
traversing the first quad tree via a first path from the first root node to the first node; and
traversing the second quad tree via a second path identical to the first path to reach from the second root node to the second node.

8. The method of claim 1, wherein building each of the first quad tree and the second quad tree comprises:
identifying a unique identifier for each map feature of the set of map features; and
generating a quad tree including nodes representing hash values for the unique identifiers for each map feature.

9. The method of claim 1, wherein building each of the first quad tree and the second quad tree comprises:
identifying a set of attributes for each map feature of the set of map features; and
generating a quad tree including nodes representing hash values for the set of attributes for each map feature.

10. The method of claim 1, wherein building each of the first quad tree and the second quad tree comprises:
selecting a subset of map features from the set of map features, wherein the subset of map features is selected based on a map feature type;
generating a quad tree, the quad tree summarizing the selected subset of map features.

11. A method for comparing map builds using tree data structures, the method comprising:
receiving a first tree data structure, the first tree data structure summarizing a first set of map features of a first map build for a geographic region, wherein a tree data structure comprises nodes associated with a portion of the geographic region and storing a hash value based on the portion of the geographic region;
receiving a second tree data structure, the second tree data structure summarizing a second set of map features of a second map build for the geographic region;
receiving, from a client device, a request to compare the first map build and the second map build;
identifying a first node of the first tree data structure and a second node of the second tree data structure corresponding to the first node of the first tree data structure such that the hash value associated with the first node is distinct from the hash value associated with the second node;
identifying one or more features from the first and second sets of map features, the one or more features representing a difference between the portion of the geographic region corresponding to the first node and the portion of the geographic region corresponding to the second node; and
transmitting data describing the one or more features to the client device for display via a user interface.

12. The method of claim 11, wherein receiving each of the first and second tree data structures further comprises:
receiving a map build for a geographic region, the map build including a set of map features, wherein each map feature is associated with a location within the geographic region and has one or more attributes; and
building the tree data structure, the tree data structure summarizing the set of map features of the map build.

13. The method of claim 12, wherein building the tree data structure comprises:
identifying a unique identifier for each map feature of the set of map features;
identifying a set of attributes for each map feature of the set of map features; and
generating the tree data structure including nodes representing hash values for the unique identifiers and attributes for each map feature.

14. The method of claim 12, wherein building the tree data structure comprises:
identifying a unique identifier for each map feature of the set of map features; and
generating the tree data structure including nodes representing hash values for the unique identifiers for each map feature.

15. The method of claim 12, wherein building the tree data structure comprises:
identifying a set of attributes for each map feature of the set of map features; and
generating the tree data structure including nodes representing hash values for the set of attributes for each map feature.

16. The method of claim 12, wherein building the tree data structure comprises:
selecting a subset of map features from the set of map features, wherein the subset of map features is selected based on a map feature type;
generating the tree data structure, the quad tree summarizing the selected subset of map features.

17. The method of claim 11, wherein identifying a first node of the first tree data structure and a second node of the second tree data structure corresponding to the first node of the first tree data structure such that the hash value associated with the first node is distinct from the hash value associated with the second node further comprises:
identifying a first node in the first tree data structure, the first node including a first identifier hash value and a first feature attribute hash value;
identifying a second node in the second tree data structure, the second node corresponding to the first node in the first tree data structure and including a second identifier hash value and a second feature attribute hash value;
determining the first and second identifier hash values are identical; and
determining the first and second feature attribute hash values are different.

18. The method of claim 11, wherein a first node of the first tree data structure and a second node of the second tree data structure corresponding to the first node of the first tree data structure such that the hash value associated with the first node is distinct from the hash value associated with the second node further comprises:
identifying a node in the first tree data structure, the node including an identifier hash value; and
determining that the identifier hash value is not included in a corresponding node of the second tree data structure.

19. The method of claim 11, wherein the first tree data structure has a first root node and the second tree data structure has a second root node, and wherein identifying the first node of the first tree data structure and the second node of the second tree data structure comprises:
traversing the first tree data structure via a first path from the first root node to the first node; and
traversing the second tree data structure via a second path identical to the first path to reach from the second root node to the second node.

20. A non-transitory computer-readable medium comprising computer program instructions executable by a processor to perform operations comprising:
receiving a first map build for a geographic region, the first map build including a first set of map features, wherein each map feature is associated with a location within the geographic region and has one or more attributes;
receiving a second map build for the geographic region, the second map build including a second set of map features;
building a first quad tree based on the first map build and a second quad tree based on the second map build, wherein each of the first quad tree and the second quad tree comprises nodes, each node associated with a portion of the geographic region and storing a hash value based on the portion of the geographic region, wherein the hash value of a node is determined based on one or more of: map features of the portion of the geographic region associated with the node or hash values of one or more nodes below the node;
receiving, from a client device, a request to compare the first map build and the second map build;
identifying a first node of the first quad tree and a second node of the second quad tree corresponding to the first node of the first quad tree such that the hash value associated with the first node is distinct from the hash value associated with the second node;
identifying one or more features from the first and second sets of map features, the one or more features representing a difference between the portion of geographic region corresponding to the first node and the portion of geographic region corresponding to the second node; and
transmitting data describing the one or more features to the client device for display via a user interface.
